(19) United States
(12) Patent Application Publication
(10) Pub. No.: US 2008/0199191 A1
(43) Pub. Date: Aug. 21, 2008

(54) MAXIMUM LIKELIHOOD SEQUENCE ESTIMATION FOR HIGH SPECTRAL EFFICIENCY OPTICAL COMMUNICATION SYSTEMS

(75) Inventors: Rene-Jean Essiambre, Red Bank, NJ (US); Michael Rubsamen, Aachen (DE); Peter Winzer, Aberdeen, NJ (US)

Correspondence Address: BROSEMER, KOLEFAS & ASSOCIATES, LLC - (LUCENT), 1 BETHANY ROAD, BUILDING 4 - SUITE # 58, HAZLET, NJ, 07730, US

(73) Assignee: LUCENT TECHNOLOGIES INC., Murray Hill, NJ (US)

(21) Appl. No.: 11/306,177

(22) Filed: Dec. 19, 2005

(51) Int. Cl. H04B 10/06; H04L 27/06

(52) U.S. Cl. 398/208; 375/341

(57) ABSTRACT

Severe inter-symbol interference (ISI), introduced by narrow-band optical filtering in high spectral efficiency wavelength-division multiplexed (WDM) systems to avoid coherent WDM crosstalk, can be substantially mitigated by the use of maximum-likelihood sequence estimation (MLSE) reception. Compared to conventional threshold detection, the use of an MLSE receiver allows, for example, a 22% reduction in optical receive filter bandwidth. For tight optical filtering, the MLSE receiver benefits from taking into account noise correlation. MLSE receivers with one and with two samples per bit are described and it is shown that while oversampling is beneficial for wide-band optical filters, the benefit goes away for narrow-band optical filtering, thereby facilitating MLSE design for rates beyond 10 Gb/s.

### FIELD OF THE INVENTION

The present invention relates to the field of high-speed optical data communications, and in particular, to the detection of signals in high spectral efficiency optical communication systems.

### BACKGROUND INFORMATION

Maximum likelihood sequence estimation (MLSE) receivers have been used in fiber optic communication systems operating at data rates up to 10 Gb/s to counteract signal distortions due to chromatic and polarization-mode dispersion. (See, e.g., H. F. Haunstein et al., “Principles for Electronic Equalization of Polarization-Mode Dispersion,” J. Lightwave Technol., vol. 22, pp. 1169-1182, 2004; F. Buchali et al., “Viterbi equalizer for mitigation of distortions from chromatic dispersion and PMD at 10 Gb/s,” in Proc. Opt. Fiber Commun. Conf. (OFC), MF85, 2004; A. Farbert et al., “Performance of a 10.7-Gb/s receiver with digital equalizer using maximum likelihood sequence estimation,” Proc. European Conf.on Opt. Commun. (ECOC), p. Th4.1.5, 2004; and J. J. Lepley et al., “Excess penalty impairments of polarization shift keying transmission format in presence of polarization mode dispersion,” IEEElectron. Lett., vol. 36, no.8, pp.736-737, 2000.)

MLSE has also been used to mitigate distortions due to narrow-band electrical filtering such as might be found in optical receivers. (See, e.g., F. Buchali et al., “Correlation sensitive Viterbi equalization of 10 Gb/s signals in bandwidth limited receivers,” Proc. Opt. Fiber Commun. Conf. (OFC), OFO2, 2005; and H. F. Haunstein et al., “Optimized Filtering for Electronic Equalizers in the Presence of Chromatic Dispersion and PMD,” Proc. Opt. Fiber Commun. Conf. (OFC), MF63, 2003.)

In wavelength-division multiplexed (WDM) optical transmission systems operating at high spectral efficiencies, narrow-band optical filtering by means of WDM multiplexers and demultiplexers has been used to avoid coherent WDM crosstalk. (See P. J. Winzer, et al., “Coherent Crosstalk in Ultradense WDM Systems,” J. Lightwave Technol., vol. 23, pp. 1734-1744, 2005.)

### SUMMARY OF THE INVENTION

In an exemplary embodiment, the present invention provides a high spectral efficiency optical communication system comprising narrow-band optical filtering, at the transmitter, the receiver, or within the transmission line, and a maximum likelihood sequence estimation (MLSE) receiver for detecting signals subjected to the narrow-band optical filtering. In accordance with the present invention, MLSE is used to counteract signal distortions due to the narrow-band optical filtering, thereby allowing for narrower optical filters and consequently for systems with higher spectral efficiencies.

### BRIEF DESCRIPTION OF THE DRAWINGS

FIG. 1A is a block diagram of a model of an exemplary embodiment of an optical communication system in accordance with the present invention and FIG. 1B is a block diagram of an exemplary embodiment of an optical receiver in the system of FIG. 1A.

FIGS. 2A and 2B are eye diagrams of the detected data signal at the receiver of the exemplary system, illustrating exemplary sampling instants for one and two samples per bit, respectively.

FIG. 3 is a trellis structure for an exemplary four-state MLSE receiver for use in accordance with the present invention.

FIGS. 4A through 4C show the noise correlation between two signal samples spaced apart by two, one, and one-half bit periods, respectively, as a function of the optical receive filter bandwidth.

FIGS. 5A and 5B illustrate the performance of exemplary receivers for a first and a third-order Gaussian optical filter, respectively.

### DETAILED DESCRIPTION

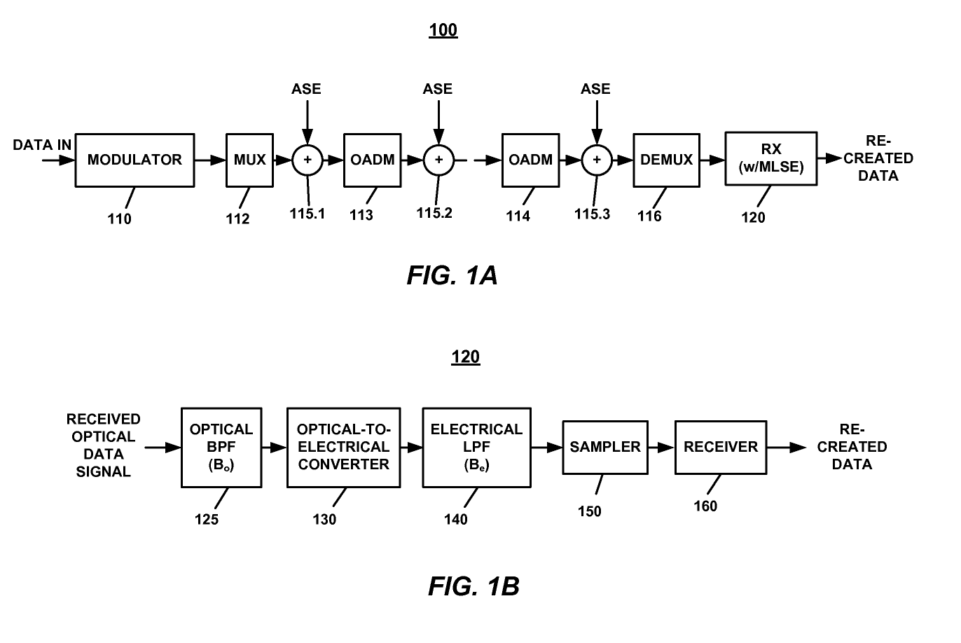

FIG. 1A is a block diagram of a model of an exemplary embodiment of an optical communication system 100 in accordance with the present invention. A data bit stream â₁, â₂, . . . , âₙ is modulated by a modulator 110 into an optical data signal. The modulator 110, may be, for example, a Mach-Zehnder modulator and the optical signal may be a chirp-free non return-to-zero (NRZ), on-off-keying (OOK) signal with a bit rate R_{bit} of 43 Gb/s. As will be evident of one of ordinary skill in the art, the present invention is not limited to a particular signal format, modulation or rate.

The system 100 may include a variety of components between the modulator 110 and an optical receiver 120, including, for example, a WDM multiplexer 112, one or more optical add/drop multiplexers (OADMs) 113, 114, and a WDM demultiplexer 116. Each of these components may introduce some optical filtering to the optical data signal before it reaches the optical receiver 120. The optical receiver 120 may also further optically filter the signal before detecting it.

As shown in FIG. 1A, amplified spontaneous emission (ASE) can be added at several points 115.1-115.3 in the communication system. ASE can be modelled as additive white Gaussian noise for both quadratures and can be added independently to each of the polarization modes typically carried by a single-mode optical fiber.

FIG. 1B is a block diagram of an exemplary embodiment of the optical receiver 120. At the optical receiver 120, the noisy signal is filtered by an optical bandpass filter 125 of variable bandwidth Bₒ. The filter 125 can be implemented in a variety of ways, including, for example, as a first or a third-order Gaussian filter.

After the filter 125, the optical signal is provided to an optical-to-electrical converter 130. The converter 130 can be implemented, for example, with a square-law photodetector. A coherent receiver implementation can also be used.

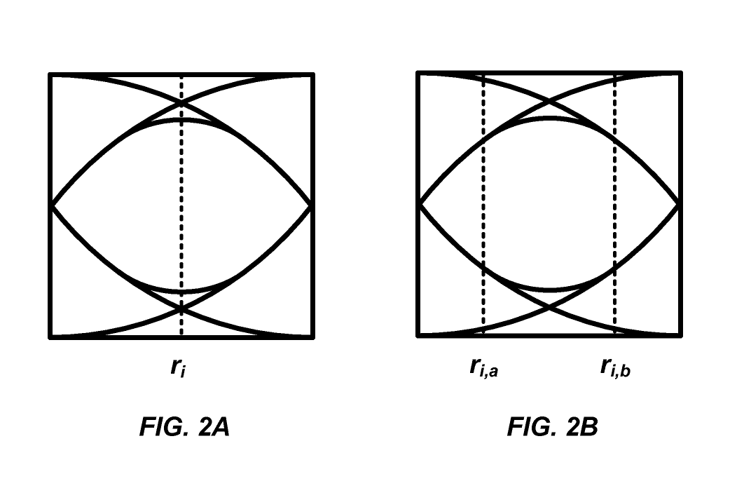

The resultant electrical signal is filtered by a low-pass filter 140 of bandwidth Bₑ. The filter 140 can be implemented, for example, as a fifth-order Bessel low-pass filter, with a bandwidth Bₑ that is approximately 0.5 to 1.0 R_{bit} (e.g., 0.75R_{bit}). The filtered electrical signal is then sampled by a sampler 150 at or above the bit rate. FIGS. 2A and 2B show the sampling instants for each case, respectively.

The samples are then processed by a receiver 160. The detected data sequence is denoted ã₁, ã₂, . . . , ãₙ which should, ideally, be equal to the transmitted data bit stream â₁, â₂, . . . , âₙ.

In a first exemplary embodiment of the present invention, the receiver 160 comprises a correlation-insensitive MLSE receiver and the electrical signal is sampled once per bit. As shown in FIG. 2A, the one sample per bit is preferably taken at or in the vicinity of the maximum eye opening. Note that for severe signal distortions, the eye diagram might be completely closed, and the “eye opening” may disappear. This possibility, however, does not preclude the applicability of the present invention.

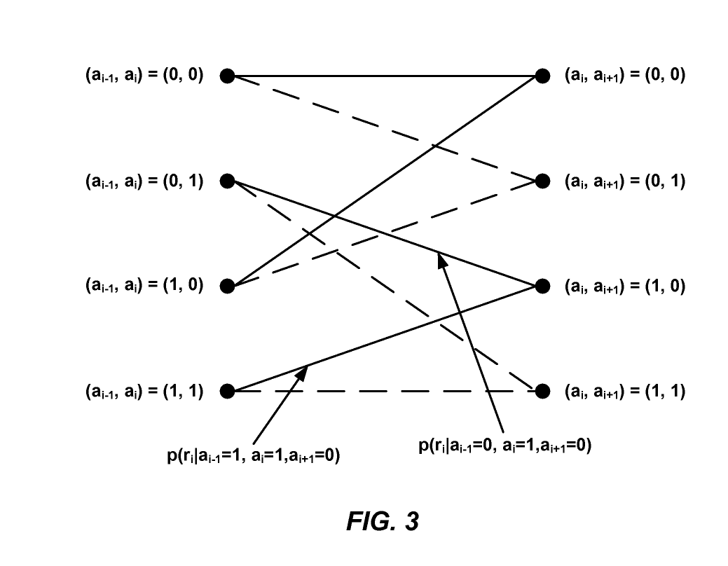

For an optical bandpass filter 125 bandwidth Bₒ>0.8R_{bit}, inter-symbol interference (ISI) will affect the neighboring bits on each side of the interference; i.e. the noisy signal sample rᵢ is affected by bits aᵢ₋₁, aᵢ, and aᵢ₊₁. In such an embodiment, the MLSE receiver 160 preferably has a 4-state trellis structure, as shown in FIG. 3. The MLSE branch metrics of the underlying 4-state trellis are p(rᵢ|aᵢ₋₁, aᵢ, aᵢ₊₁). The MLSE traceback length is 10, i.e. the MLSE receiver makes a decision on a bit after processing 10 steps of the trellis.

With an optical bandpass filter 125 bandwidth Bₒ>0.5R_{bit}, inter-symbol interference (ISI) will affect the two neighboring bits on each side of the interference; i.e. the noisy signal sample rᵢ is affected by bits aᵢ₋₂, aᵢ₋₁, aᵢ, aᵢ₊₁, and aᵢ₊₂. In such an embodiment, the MLSE receiver 160 preferably has a 16-state trellis structure. The MLSE branch metrics of the underlying 16-state trellis are p(rᵢ|aᵢ₋₂, aᵢ₋₁, aᵢ, aᵢ₊₁, aᵢ₊₂).

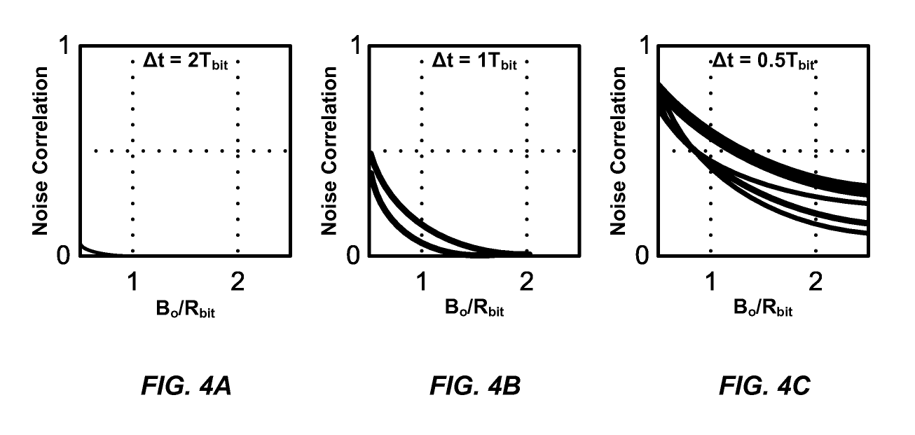

In a further exemplary embodiment of the present invention, the receiver 160 comprises a correlation-sensitive MLSE receiver and the electrical signal is sampled once per bit. FIGS. 4A-C depict the noise correlation between two samples r(t) and r(t+Δt) for various Δt as a function of the optical filter 125 bandwidth Bₒ. The correlation can be determined separately for each bit pattern by means of Monte-Carlo simulations, for example. The resultant pattern-dependent spread of the correlation curves reflects the signal-dependent nature of beat noise. FIG. 4B shows significant noise correlation across one bit (Δt=1T_{bit}) for Bₒ<R_{bit}. In comparison, the correlation across two bits (Δt=2T_{bit}, FIG. 4A) is negligibly small. Therefore, in performing the MSLE, it is possible to only take into account the noise correlation across one bit, using the branch metrics p(rᵢ|rᵢ₊₁, aᵢ₋₂, aᵢ₋₁, aᵢ, aᵢ₊₁, aᵢ₊₂, aᵢ₊₃). The branch metrics can be estimated for each bit pattern individually by a variety of methods, including, for example, using histograms obtained through Monte-Carlo simulations, and subsequent smoothing using a kernel density estimation method. (See, e.g., B. W. Silverman, “Density estimation for statistics and data analysis,” Chapman and Hall, 1986.)

In yet a further exemplary embodiment of the present invention, the receiver 160 comprises a correlation-insensitive MLSE receiver and the electrical signal is sampled twice per bit. As shown in FIG. 2B, the two samples per bit, r_{i,a} and r_{i,b} for bit aᵢ, are preferably symmetrically centered around the maximum eye opening, if the distortions are such that an eye opening still exists. The resulting branch metrics are p (r_{i,a}|aᵢ₋₂, aᵢᵢ₋₁, aᵢ, aᵢ₊₁, aᵢ₊₂)·p(r_{i,b}|aᵢ₋₂, aᵢ₋₁, aᵢ, aᵢ₊₁, aᵢ₊₂) for the 16-state trellis. Because of significant noise correlation at Δt=T_{bit} for Bₒ<R_{bit}, the probability density function of sample r_{i,a} depends on two other samples, r_{i,b} and r_{i+1,a}.

In yet a further exemplary embodiment of the present invention, the receiver 160 comprises a correlation-sensitive MLSE and the electrical signal is sampled twice per bit.

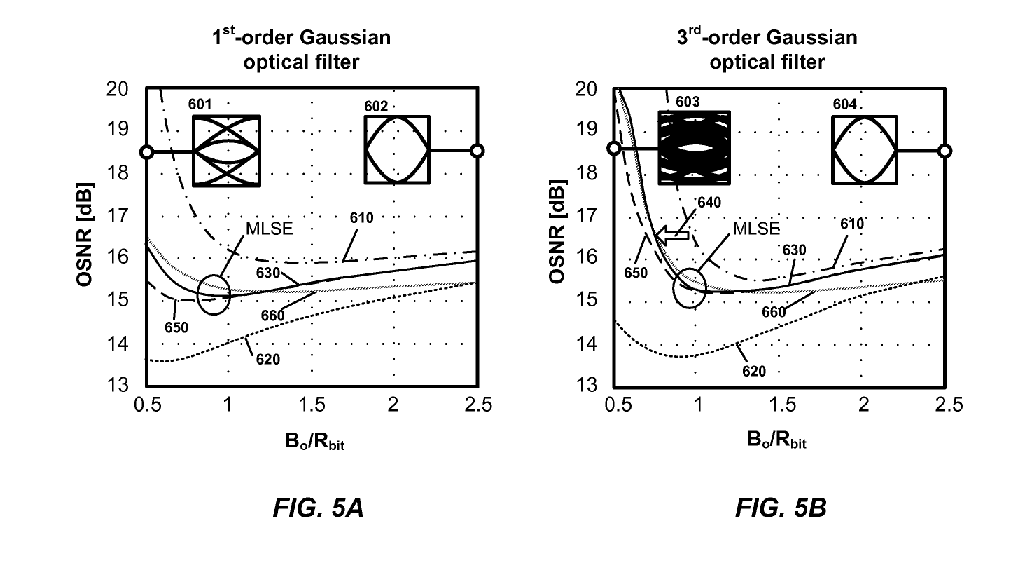

Performance results of the various embodiments described above will now be discussed with reference to FIGS. 5A and 5B. The optical-signal-to-noise ratio (OSNR) at the input to the optical receiver 120 that is required for operation at a predetermined bit error ratio (BER) (e.g., 10⁻³) can be used for purposes of measuring performance. The OSNR is defined as Pₛ/(2N_{ASE}B_{ref}), where Pₛ is the optical signal power entering the receiver, N_{ASE} is the ASE power spectral density per polarization, B_{ref} is the reference bandwidth (e.g., 12.5 GHz), and the factor of 2 takes into account both ASE polarizations.

FIGS. 5A and 5B show the required OSNR (into the receiver 120) as a function of receive filter bandwidth Bₒ for MLSE and conventional threshold receivers, for 1st-order and 3rd-order Gaussian optical filter characteristics, respectively. Eye diagrams of the electrical signal at the sampling circuit for different optical filter bandwidths are shown in insets 601-604. Note that for the sake of simplicity, the optical filtering introduced by the various components (112, 113, 114, 116, 120) in the system 100, discussed above in connection with FIG. 1A, are modeled by the optical BPF 125 for purposes of generating the results of FIGS. 5A and 5B.

In FIGS. 5A and 5B, the dash-dotted curves 610 represent the OSNR performance using a conventional threshold receiver with optimized decision threshold where the data received is a de Brujin bit sequence (DBBS). The dotted curves 620 represent the ISI-free performance of the conventional threshold receiver as a baseline, assuming the transmission of isolated ‘1’s and ‘0’s (i.e., isolated to the extent that the bits are far enough apart so that the filter-induced spreading of the ‘1’-bit will not affect the ‘0’ bit.)

For small Bₒ, the performance of the threshold receiver using the DBBS data (610) degrades due to ISI and due to attenuation by spectral signal truncation. The ISI-free curve 620 is affected by only the latter of the two effects. The difference between the two curves 610 and 620 for the conventional threshold receiver quantifies the ISI penalty.

The solid black curves 630 in FIGS. 5A and 5B represent the performance of the correlation-insensitive MLSE receiver with one sample per bit, described above. The curves 630 show that this receiver partially compensates for ISI, as it outperforms the conventional threshold receiver for at least the entire range of Bₒ shown (0.5-2.5R_{bit}). Using an MLSE receiver therefore allows for narrower optical filtering, which in turn reduces coherent wavelength division multiplex (WDM) crosstalk, thereby facilitating high spectral efficiency WDM systems. For example, as indicated in FIG. 5B by the arrow 640 for a 3rd-order Gaussian optical filter, the use of an MLSE receiver allows for a filter bandwidth reduction from approximately 0.98R_{bit} to as low as 0.76R_{bit} with only a 1 dB OSNR penalty.

In FIGS. 5A and 5B, the dashed curves 650 represent the correlation-sensitive MLSE receiver with one sample per bit, as described above. For Bₒ<R_{bit}, for which FIG. 4B predicts significant noise correlation, the correlation-sensitive MLSE receiver shows improved performance over the correlation-insensitive MLSE receiver. For larger optical filter bandwidths, the correlation-sensitive MLSE accurately reproduces the results of the correlation-insensitive MLSE (represented by the curves 630).

In FIGS. 5A and 5B, the gray curves 660 represent the performance of the correlation-insensitive MLSE receiver with two samples per bit, as described above. This receiver shows a better performance than the MLSE receiver with one sample/bit for large optical filter bandwidths (as represented by the curves 630 and 650). As can be seen in FIGS. 5A and 5B, however, the improvement that results from having a second sample per bit goes away for narrow-band optical filtering. This can be understood from the fact that small optical filter bandwidths make adjacent signal samples less independent, thus reducing the additional information that can be obtained from over-sampling. Avoiding over-sampling significantly facilitates the implementation of MLSE receivers that operate at rates beyond 10 Gb/s.

It is understood that the above-described embodiments are illustrative of only a few of the possible specific embodiments which can represent applications of the present invention. Numerous and varied other arrangements can be made by those skilled in the art without departing from the spirit and scope of the invention.

What is claimed is:

1. An optical data communications system comprising:
a narrow-band optical filter, the narrow-band optical filter filtering an optical data signal;
a converter, the converter converting the filtered optical data signal to an electrical data signal; and
a receiver, the receiver generating a recreated data signal based on the electrical data signal, wherein the receiver includes a maximum likelihood sequence estimation (MLSE) receiver.

2. The system of claim 1, wherein the narrow-band optical filter is provided in at least one of a multiplexer, an optical add/drop multiplexer, a demultiplexer and an optical receiver.

3. The system of claim 1, wherein the MLSE receiver includes a four-state trellis structure.

4. The system of claim 1, comprising a sampler, the sampler generating at least one sample per bit of the electrical data signal, wherein the MLSE receiver generates the recreated data signal based on the samples.

5. The system of claim 4, wherein the sampler generates at least two samples per bit of the electrical data signal.

6. The system of claim 1, wherein the narrow-band optical filter includes a band-pass filter with a bandwidth less than a bit rate of the optical data signal.

7. The system of claim 6, wherein the band-pass filter has a bandwidth no greater than 0.76 times the bit rate of the optical data signal.

8. The system of claim 6, wherein the band-pass filter includes a first- or a third-order Gaussian filter.

9. The system of claim 1, comprising an electrical filter coupled to the converter for filtering the electrical data signal.

10. The system of claim 9, wherein the electrical filter includes a low-pass filter with a bandwidth that is approximately 0.5 to 1.0 times a bit rate of the electrical data signal.

11. The system of claim 1, wherein the MLSE receiver is correlation-insensitive.

12. The system of claim 1, wherein the MLSE receiver is correlation-sensitive.

13. A wavelength-division multiplexed communication system comprising the system of claim 1.

14. A method of using maximum likelihood sequence estimation (MLSE) to determine a content of an optical data signal, comprising steps of:
narrow-band filtering an optical data signal;
converting the filtered incoming optical data signal to an electrical data signal; and
generating a recreated data signal based on the electrical data signal, wherein the step of generating the recreated data signal includes performing a maximum likelihood sequence estimation based on the electrical data signal.

15. The method of claim 14, wherein the MLSE is performed in accordance with a four-state trellis structure.

16. The method of claim 14, comprising sampling the electrical data signal at least once per bit, wherein the MLSE is based on the samples.

17. The method of claim 14, wherein the narrow-band filtering includes band-pass filtering with a bandwidth less than a bit rate of the optical data signal.

18. The method of claim 17, wherein the band-pass filtering has a bandwidth no greater than 0.76 times the bit rate of the optical data signal.

19. The method of claim 14, comprising filtering the electrical data signal.

20. The method of claim 19, wherein the filtering of the electrical data signal includes low-pass filtering with a bandwidth that is approximately 0.5 to 1.0 times a bit rate of the electrical data signal.

21. The method of claim 14, wherein the MLSE is correlation-insensitive.

22. The method of claim 14, wherein the MLSE is correlation-sensitive.
